(19) United States
(12) Patent Application Publication
(10) Pub. No.: US 2010/0280817 A1
(43) Pub. Date: Nov. 4, 2010

(54) DIRECT POINTER ACCESS AND XIP REDIRECTOR FOR EMULATION OF MEMORY-MAPPED DEVICES

(75) Inventor: Markus Unseld, Elchingen (DE)

Correspondence Address: FLH/Spansion;c/o Frommer Lawrence & Haug, 745 Fifth Avenue, New York, NY, 10151, US

(73) Assignee: Spansion LLC, Sunnyvale, CA (US)

(21) Appl. No.: 12/433,159

(22) Filed: Apr. 30, 2009

(51) Int. Cl. G06G 7/62; G06F 13/24; G06F 12/16; G06F 12/02

(52) U.S. Cl. 703/21; 710/260; 711/163; 711/103; 711/E12.103; 711/E12.008

(57) ABSTRACT

A system, apparatus and method for emulating memory-mapped devices in the development of software where a device is mapped to protected memory space. When an instruction causing an attempted read or write to the protected space occurs, an exception or interrupt occurs, the instruction is analyzed and converted into a function call. The function call is sent to a device simulator for execution. The results of the function call are then used to update the registers of the processor and execution of application program will resume at a subsequent instruction.

### TECHNICAL FIELD

The present disclosure relates generally to a system and method for emulating memory-mapped devices in the development of software. More specifically, but not exclusively, the disclosure describes mapping a device to protected memory space such that a memory access to the protected memory space is re-directed and converted into a function call that is executed through a device simulator.

### BACKGROUND

Many electronic products implement their functionality through a central processing unit, a processor or controller (“microprocessor”) and related components. Such microprocessor-based systems provide cost savings during development, flexibility in functionality, the ability to more easily interface with other components and decrease costs in development of successive generations of products. When implementing a microprocessor-based electronic product, various additional components may be required whether part of the central architecture of the microprocessor or as peripheral devices. These additional components may be input/output devices, memory devices or the like. As one example, the microprocessor may communicate with a display device, a user input device such a keyboard and several types of memory such as RAM, ROM and flash memory. The microprocessor communicates with these devices typically over an address bus and a data bus.

These devices may be accessed directly by the processor or may be accessed by other devices. The components used in conjunction with a microprocessor, such as flash memory, may be memory-mapped devices. Memory-mapped input/output (“I/O”) uses the same address bus to address both memory and I/O devices. To accommodate the I/O devices, areas of the addressable space are reserved for I/O rather than memory. The reservation might be temporary or permanent. Each I/O device monitors the microprocessor's address bus and responds to any access of device-assigned address space, connecting the data bus to the hardware register of the appropriate device. The common read and write commands provided by a microprocessor access and control these devices. The commands may be an assembler read or write instruction, or a pointer read or write instruction from a high level language. The memory-mapped devices may also be accessed by other components through direct memory access (“DMA”). DMA is a feature of modern computers and microprocessors that allows certain hardware subsystems within the computer to access system memory for reading and/or writing independently of the central processing unit. Many hardware systems use DMA including disk drive controllers, graphics cards, network cards, sound cards and GPUs.

As new electronic products are being developed or existing products are being upgraded by manufacturers, the individual component devices may or may not also be under development. As an example, devices such as flash memories are constantly under development to improve their speed, storage capacity and to decrease their cost, size and power consumption. At times, a component product may have specifications, but the actual component product is not yet available for testing or implementation. However, in the development process of new electronic products, the manufacturer typically may need to create, test and debug software. Such software may be developed in the target system or may be developed through an emulator or simulator program. An emulator duplicates the functions of one system using a different system, so that the second system behaves like and appears to be the first system. The host computer may emulate a target operating system or may emulate certain aspects of the target device. Both the operating system and the application software will be interpreted by the emulator, rather than being run by native hardware. Apart from this interpreter for the emulated machine's language, some other hardware (such as input or output devices) must be provided in virtual form as well; for example, if writing to a specific memory location should influence the screen, then this would need to be emulated. By emulating the hardware environment within a host PC, the software development can begin and may potentially be completed before the availability of the actual hardware.

Since memory management software such as drivers, flash file systems, and the like, are typically doing direct pointer or direct memory accesses, it is difficult to develop and use emulators for such memory management software. Thus, the development and testing of memory management software typically occurs on the target system, for example where the memory management software being developed is such things as flash drivers, flash file systems and the like.

It is in light of this background that the invention is contemplated.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings, wherein:

FIG. 1 is a system diagram of one embodiment of an environment in which the invention may be practiced;

FIG. 2 shows one embodiment of a network device that may be included in a system implementing the invention;

FIG. 3 shows a diagram of one embodiment of an aspect of the invention;

FIG. 4 is an architectural overview of the operation of one embodiment;

FIG. 5 shows a flow diagram for one method of implementing the invention; and

FIG. 6 illustrates a flow diagram for one method of implementing the invention.

### DETAILED DESCRIPTION

Various embodiments now will be described more fully hereinafter with reference to the accompanying drawings, which form a part hereof, and which show, by way of illustration, specific embodiments. However, this invention may be embodied in many different forms and should not be construed as limited to the embodiments set forth herein. Rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. Therefore, the following detailed description is not to be taken in a limiting sense.

Throughout the specification and claims, the following terms take the meanings explicitly associated herein, unless the context clearly dictates otherwise. The phrase “in one embodiment” does not necessarily refer to the same embodiment, although it may. Furthermore, the phrase “in another embodiment” does not necessarily refer to a different embodiment, although it may. Thus, as described below, various embodiments of the invention may be readily combined without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The term “protected memory space” means memory space wherein any attempted read operation from this memory space or any attempted write operation to this memory space will cause an exception, interrupt or equivalent response to the operation.

The term “device simulator” or “simulator” means software, a combination of software and hardware, or hardware that simulates a hardware device. A simulator may be a pin-level simulation device that simulates the signaling that would take place on the pins of the device. A simulator may also offer other types of interfaces, such as providing read/write functions without pin toggling. Alternatively, a simulator may imitate the actions of a cache, microcontroller or other devices that may be part or used in conjunction with the device. One example of a common simulator is the Denali MMAV.

The term “memory-mapped device” means a device in which the input and output of the device are mapped into the memory space of a microprocessor, controller or the like to control the device. The device may or may not be considered a peripheral device. As an example, a flash memory or a display adapter may be a memory-mapped device.

The following briefly describes the embodiments of the invention to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

In one embodiment, a device is mapped to protected memory space. The memory space is protected from read and write accesses, wherein any attempt to read or write into the memory space will result in an exception or interrupt. The exception or interrupt will prevent execution of the instruction and start a secondary process. In operation, the host system emulates the target application program, executing the instructions. When an instruction causing an attempted read or write to the protected space occurs, execution of the instruction is stopped. The instruction may be analyzed and converted into a function call. The function call may be sent to a device simulator for execution. The results of the function call are used to update the registers of the processor and execution of application program resumes at a subsequent instruction.

In another embodiment, the interruption of the current program is a hardware interrupt or exception, and more specifically is a hardware interrupt generated by a memory management unit of a host computer. In yet another embodiment, the function call may be converted to a form suitable for transmission over a network to be executed by a simulator located remotely from the host computer. The simulator may simulate caching operations, microcontroller operations and/or the response of a pin-level device. In another embodiment, the direct pointer accesses in the application software may be replaced by dedicated function calls and the simulator may be called directly by the application software.

### Illustrative Operating Environment

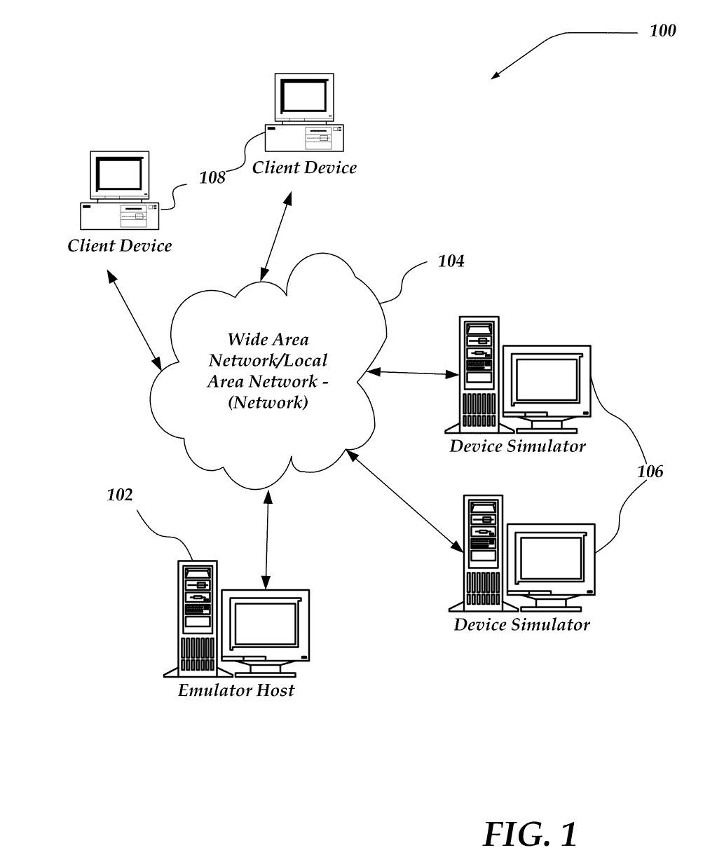

FIG. 1 shows components of one embodiment of an environment in which the invention may be practiced. Not all the components are required to practice embodiments, and variations in the arrangement and type of the components may be made without departing from the spirit or scope of the invention. As shown, system 100 of FIG. 1 includes local area networks (“LANs”)/wide area networks (“WANs”) (collectively, “network”) 104, client devices 108, emulator host 102, and device simulators 106.

Client device 108 may include virtually any computing device that typically connects using a wired or wireless communications medium such as personal computers, multiprocessor systems, microprocessor-based or programmable consumer electronics, network PCs, or the like. In one embodiment, client devices 108 may be configured to operate over a wired and/or a wireless network. A web-enabled client device may include a browser application that is configured to receive and to send web pages, web-based messages, or the like. The browser application may be configured to receive and display graphics, text, multimedia, or the like, employing virtually any web-based language.

Client devices 108 may also include at least one other client application that is configured to receive content from another computing device. The client application may include a capability to provide and receive textual content, multimedia information, or the like. The client application may further provide information that identifies itself, including a type, capability, name, or the like. In one embodiment, client devices 108 may uniquely identify themselves through any of a variety of mechanisms, including a network address or other device identifier. The information may also indicate a content format that the client device is enabled to employ. Such information may be provided in a communication, or the like, sent to another computing device.

Client devices 108 may further be configured to include a client application that enables the user to log into a user account that may be managed by another computing device, such as emulator host 102, device simulator 106 or the like. Managing of communications may also be performed without logging into a user account.

Network 104 is configured to couple emulator host 102 and its components with other computing devices, including, device simulators 106 and client devices 108. Network 104 is enabled to employ any form of computer readable media for communicating information from one electronic device to another. Also, network 104 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 104 includes any communication method by which information may travel between computing devices.

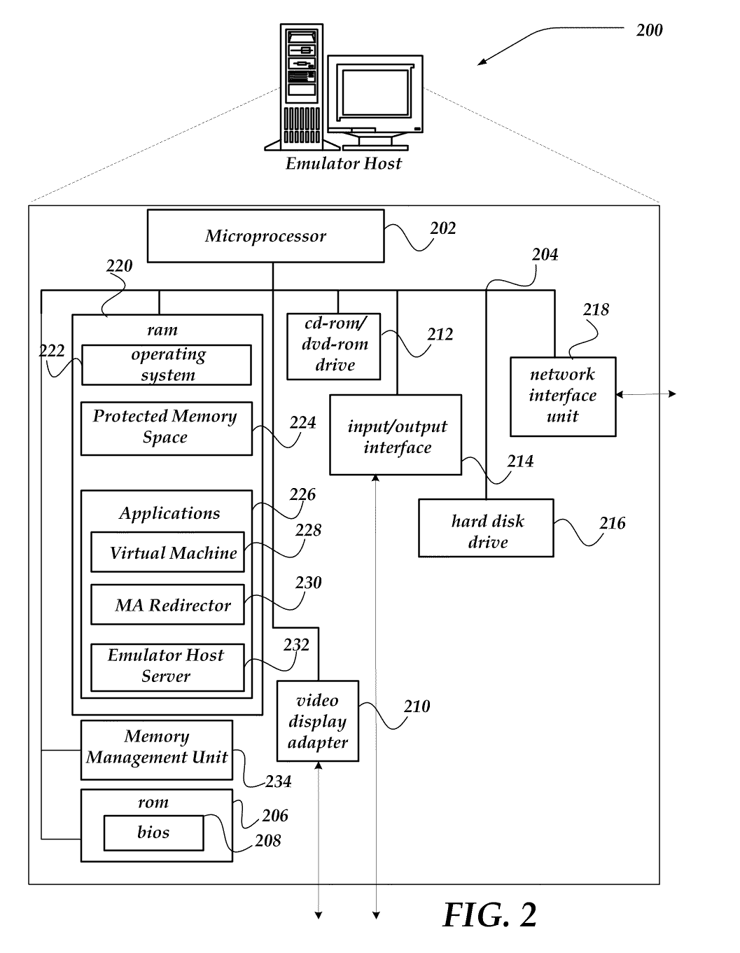

An emulator host 102 is described in more detail below in conjunction with FIG. 2. Briefly, however, emulator host 102 may include any computing device capable of connecting to network 104 to enable emulation of a target device or system.

In one embodiment, emulator host 102 may contain programs that permit emulation of a target system to enable the running, testing and debugging of software. In particular, emulator host 102 may contain a memory redirection mechanism for converting memory accesses to memory-mapped devices to a function call that may be executed by a simulator. The emulation program for the software may be accessed directly through emulator host 102. Alternatively, the emulation program for the software may be accessed within emulator host 102 remotely through client devices 108 and network 104. In yet another embodiment of the system, client devices 108 may contain all or part of the emulation program for the software. Moreover, in another embodiment, various functions performed by emulator host 102 may be distributed across a plurality of network devices or client devices.

Devices that may operate as emulator host 102 may include personal computers, desktop computers, multiprocessor systems, microprocessor-based or programmable consumer electronics, network PCs, servers, or the like.

Device simulators 106 include virtually any network computing device that is configured to provide simulation of memory-mapped devices over network 105. The simulation may be pin-level simulation of part or all of the memory-mapped devices. Alternatively, the simulation may include caching and microcontroller functions. Devices that may operate as device simulators 108 include, but are not limited to personal computers, desktop computers, multiprocessor systems, microprocessor-based or programmable consumer electronics, network PCs, servers, network appliances, and the like. Moreover, while emulator host 102 and device simulator 106 are illustrated as distinct devices, the invention is not so limited. For example, in one embodiment, emulator host 102 and device simulator 106 may be implemented within a stand alone host device, a single network device, or distributed across a plurality of network devices.

### Illustrative Network Device Environment

FIG. 2 shows one embodiment of a network device, according to one embodiment. Network device 200 may include many more components than those shown. However, the components shown are sufficient to disclose an illustrative embodiment for practicing the invention. Network device 200 may represent, for example, emulator host 102 of FIG. 1.

Network device 200 includes microprocessor 202, video display adapter 210, and a mass memory, all in communication with each other via bus 204. The mass memory generally includes RAM 220, ROM 206, and one or more permanent mass storage devices, such as hard disk drive 216, tape drive, optical drive, and/or floppy disk drive 212. The mass memory stores operating system 222 for controlling the operation of network device 200. Any general-purpose operating system may be employed. Basic input/output system (“BIOS”) 208 is also provided for controlling the low-level operation of network device 200. As illustrated in FIG. 2, network device 200 also can communicate with the Internet, or some other communications network, via network interface unit 218, which is constructed for use with various communication protocols including the TCP/IP protocol. Network interface unit 218 is sometimes known as a transceiver, transceiving device, or network interface card (NIC).

The mass memory as described above illustrates another type of computer-readable media, namely computer readable storage media. Computer readable storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The memory within network device 200 may be managed by memory management unit 234. Memory management unit (“MMU”) 234, which is sometimes called paged memory management unit (PMMU), is a computer hardware component responsible for handling accesses to memory requested by central processing unit (microprocessor) 202. The functions of MMU 234 include translation of virtual addresses to physical addresses (i.e., virtual memory management), memory protection, cache control, bus arbitration, and, in simpler computer architectures (such as 8-bit systems) bank switching.

The mass memory stores program code and data. One or more applications 226 are loaded into mass memory and run on operating system 222. Examples of application programs may include transcoders, schedulers, calendars, database programs, word processing programs, HTTP programs, customizable user interface programs, IPSec applications, encryption programs, security programs, VPN programs, web servers, account management, and so forth. Applications 226 may include virtual machine 228, memory access redirector 230 (“MA Redirector”) and emulator host server 232, as described below. These applications can be based in the network device or in a distributed network. Thus, the invention may be implemented in a traditional client server arrangement, in a peer to peer network or any other architecture. Alternatively, the invention may be implemented as a software client run on currently existing platforms.

### Generalized Operation

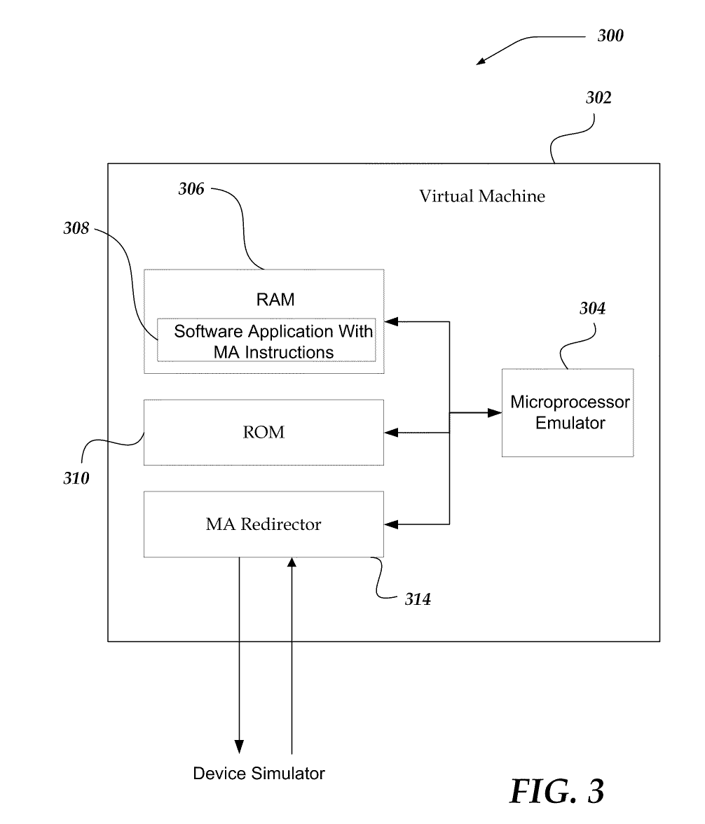

The structure of one embodiment of a method and system will now be described with respect to FIG. 3. Not all the components illustrated are required to practice embodiments, and variations in the arrangement and type of the components may also be made. Thus, virtual machine 302 may include many more or less components than those shown. However, the components shown are sufficient to disclose an illustrative embodiment.

In FIG. 3, virtual machine 302 is an example of an application that may be run on emulator host 200 as shown in FIG. 2. A virtual machine is a software implementation of a machine (e.g., a computer) that executes programs like a real machine. In this instance, virtual machine 302 may perform the role of an emulator, allowing target software applications and operating systems, and specifically the memory management software, written for the target microprocessor architecture to be run. Thus, virtual machine 302 is one example of using target operating system emulation on an emulator host computer. The virtual machine may be a system virtual machine that provides a system platform that supports the execution of a complete target operating system. Alternatively, the virtual machine may be a process virtual machine designed to run a single program, that is, it supports a single process, or a plurality of programs.

Software might be such things as low level driver software implementations, file system software implementations and memory update software implementations for use in a electronic device. There may be a significant advantage in the development time and the quality for the customer to use a device simulator during the software development phase. The benefit of being able to emulate a memory-mapped device is that it provides advanced debugging and tracing capabilities on the host system versus doing so within the target system of the electronic device being developed. The software development can begin even before the target hardware is available. The software could potentially be ready to use with the first availability of the hardware. There might be no dependency on the availability of platform hardware or the fully functional memory-mapped hardware during the development phase. Also, the software can be developed in an ideal basis without many of the difficulties that may occur because of a newly developed technology wherein hardware bugs may not be completely resolved. Such a system would also allow the testing of the memory-mapped device to failures (such as program or erase timeouts, . . . etc.) or other such simulations. Moreover, the better the simulated behavior, the better the software implementation and the subsequent testing of that implementation.

Virtual machine 302 may contain a microprocessor emulator 304 that emulates the processor of a target electronic device. The target electronic device may have memory devices that operate in conjunction with its microprocessor. The various memory functions required by microprocessor emulator 304 may be carried out by RAM 306, ROM 310, and MA redirector 314. The virtual machine may have emulator capabilities in addition to those shown here. In emulating the target environment for the testing and debugging of, for example, memory management software, processor emulator 304 may execute instructions of software application 308. Software application 308 may be resident within RAM 306, or located elsewhere within the virtual machine. Software application 308 may have memory access instructions for accessing a memory-mapped device. The memory-mapped device may be, for example, a flash memory device. The flash memory device may be mapped by the emulator to protected memory space. A direct access instruction to the memory-mapped device, and thus to the protected memory space, would trigger MA redirector 314. MA redirector 314 may be contained within virtual machine 302. Alternatively, MA redirector 314 may be an application outside of memory emulator 312, outside of virtual machine 302 or may be an application run separately on emulator host 200.

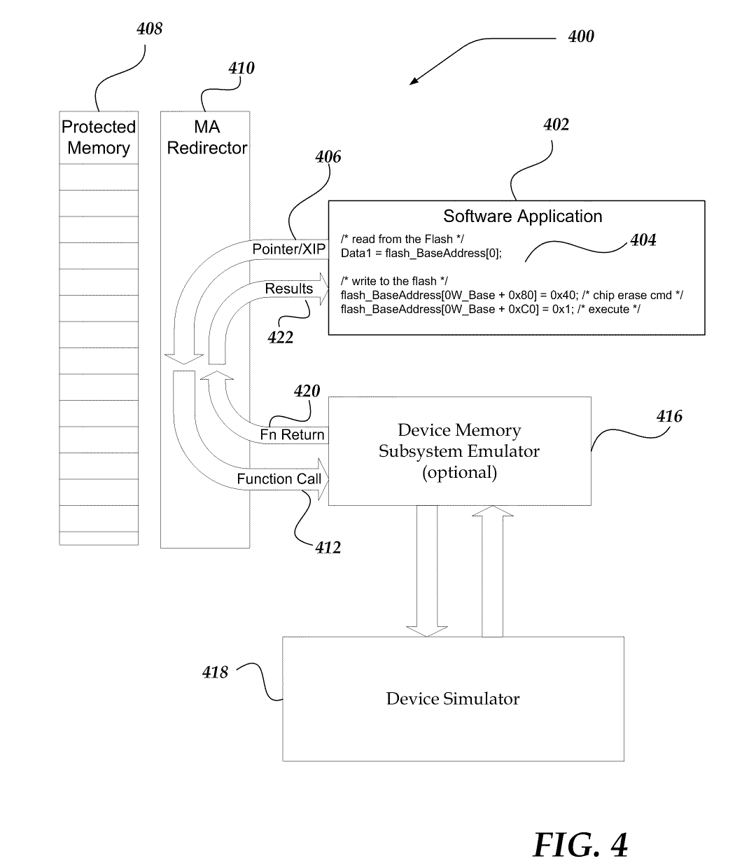

One embodiment of an architecture 400 is shown in FIG. 4. Architecture 400 may include many more or less components than those shown. However, the components shown are sufficient to disclose an illustrative embodiment. As shown in FIG. 4, protected memory space 408 is allocated to the memory-mapped device. This memory address would be protected from read and write access by, for example, the memory management unit of the emulator host, such as MMU 234 of FIG. 2. If any attempt to read from or write to the protected memory space occurs, the operating system of the host computer will stop execution of the instruction and may either generate a notification, generate an interrupt, generate an exception or the like. In another embodiment, certain partitions of the memory-mapped device may be mapped to RAM while other areas are assigned to memory protected space. This would permit direct access via pointers to the RAM area, while other areas would be re-directed to the device simulator. The benefit is that this may provide faster response times.

Software application 402 is a non-limiting example of memory management software that may be run on an emulator, such as that shown in FIG. 3. Alternatively, software application 402 may be executed outside of the context of an emulator program. The software application consists of a series of instructions 404. These instructions may consist of, among other things, pointer memory accesses and execute in place (“XIP”) instructions. XIP instructions provide a method of executing programs directly from long term storage rather than copying it into RAM before execution. As one example, instructions 404 include an instruction to read the data from the memory-mapped device, such as a flash array, that is located at the pointer Flash_BaseAddress[0] and assign the contents at address “0” to “data1”. Since the location assigned to the memory-mapped device is protected memory space, such an instruction will cause an interrupt of the execution of the instruction. The memory access instructions may also be indirect memory accesses wherein the memory access may access cached memory rather than the actual values located in the memory.

When a memory access to protected memory 408 is attempted, an interruption of the execution of the instruction occurs. This is shown by, for example, pointer/XIP 406 being redirected by MA redirector 410. In redirecting the memory access, the memory access instruction is analyzed by MA redirector 410 to determine the nature of the operation. The instruction is then converted to a function call as shown by arrow 412. The function call is sent to device simulator 418 which will simulate the operation of the memory-mapped device. Device simulator 418 may incorporate memory subsystems emulators or simulators, such as cache or a memory controller. Alternatively, device memory subsystem emulator 416 may emulate the caching and controller operations while device simulator 418 simulates the device on a pin-level. In one embodiment, an event driven pin-level interface may toggle the model pins as may be specified for the device. The pin values and timing may be passed to the device simulator. The pin values and timing are evaluated by the device simulator and an appropriate response returned back to MA redirector 410.

In another embodiment, device simulator 418 may be a physical instance of the device. In such a case, the function call must be converted to a format capable of acting on the physical instance of the device.

Device simulator 418 and optional device memory subsystem emulator 416 may generate a function return 420 after completion of the function call. Function return 420 may then be converted into results 422. These results may be actions such as data being read from memory or confirmation of data being written to a memory address. As an example, a flag may be set that data has been written to the memory location. Results 422 are used to update the registers of the processor. The instruction pointer for running software application 402 may then be incremented to point to a subsequent instruction. Execution of software application 402 then resumes at that point.

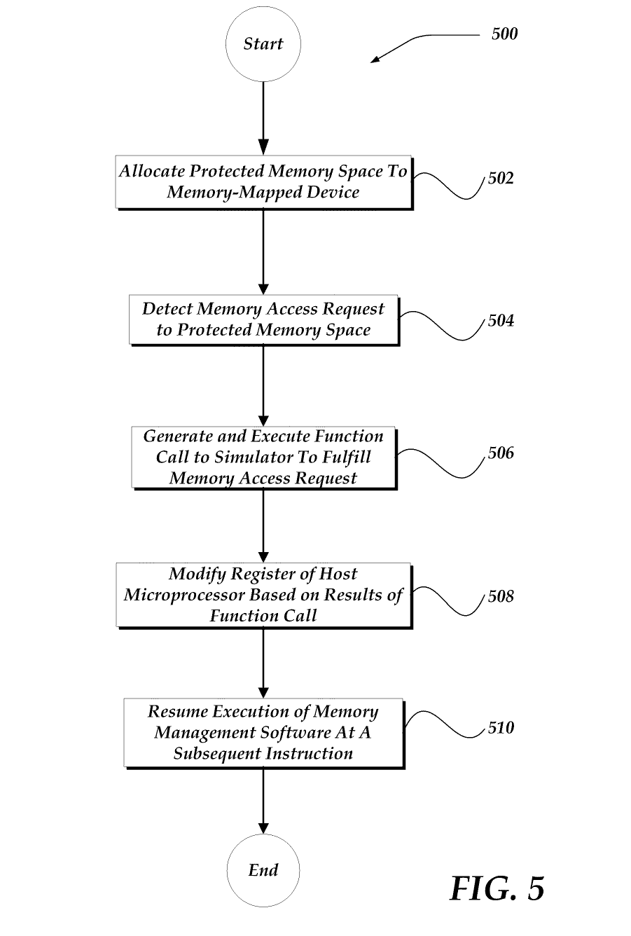

One example of the process flow for the invention is shown in FIG. 5. The process begins by allocating protected memory space to the memory-mapped device as shown in block 502. This allocation may occur prior to the start of the execution of the software, or may occur at the initial stages of execution. Next, during execution of the software in the emulator, the system would detect a memory access request to the protected memory space as shown in block 504. This detection of the memory access request may occur on a hardware level, and may generate an exception, interrupt and/or a notification. As an example, the memory access request may be detected by a memory management unit of the host processor which would generate a hardware interrupt to the microprocessor.

The hardware interrupt causes the processor to save its state of execution via a context switch, and begin execution of an interrupt handler. The memory access is parsed to determine the parameters of the request and convert the request to a function call to a device simulator as shown in block 506. The function call converts the hardware memory access into a software request to a device simulation program external to the target emulator. The device simulator program may be within the host system. Alternatively, the function call may be converted into a form that can be transmitted over a network such as by converting it into TCP/IP protocol or any similar format suitable for transmission. Thus, the device simulator fulfilling the function request may be connected through a network or the Internet. The device simulator simulates the memory access and return the results of the memory access. The memory access redirector may modify the registers of the host processor based on the results of the function call as shown in block 508. Flowing to block 510, the system resumes execution of the software at a subsequent instruction.

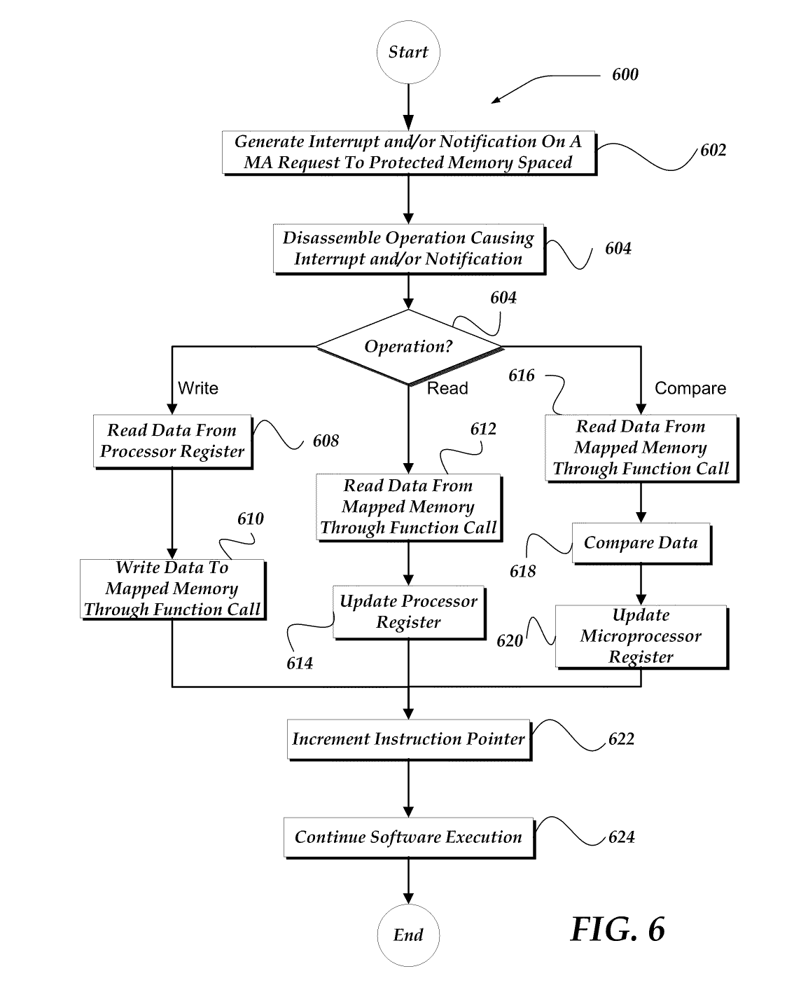

Another example of one embodiment of a process flow useable with a flash memory array is shown in FIG. 6. The flash array may be mapped to protected memory space by a host system. Processing begins, after a start block, at block 602, where the emulator may generate an interrupt and/or notification on receiving a memory access request to the protected memory space as set forth previously. Next, the operation causing the interrupt and/or notification is disassembled to determine what the operation is as shown in decision block 604. This may be a disassembling of the binary operation code, which is the portion of a machine language instruction that specifies the operation to be performed. The operation may be analyzed in terms of, for example, whether it is a read, write or other instruction, the instruction length, the involved destination and source processor registers, the data access length (byte, word, doubleword, . . . et cetera) and/or the data access address.

As an example, the operation may be a write operation, a read operation, or a compare operation shown by decision block 604. For a write operation, process 600 flows to block 608, where the data is read from the processor register and converted to an argument in a function call to the device simulator. The function call may take the form of, for example, WriteFlash(Address, Data), where the address to which the data is be written and data to be written are passed as parameters in the function call. The function call is then executed which causes the device simulator to simulate writing data to the flash array as shown in block 610.

If the operation were determined in decision block 604 to be a read operation, processing flows to block 612, where a function call is generated to read data from the device simulator through a function call. As an example, the function call my take the form of ReadFlash (Address), where the data is read from the indicated address and returned as a parameter value. This data is then used to update the microprocessor register shown in block 614. As another example, the operation in decision block 604 may be determined to be a compare operation. Process 600 continues to block 616, where data may be read from the device simulator by executing a function call seeking the data from the designated memory location within the device simulator. The data is the compared against, for example a constant or the content of another processor register, as shown in block 618. Again, the processor registers are updated with the results shown in block 620.

After the completion of the write, read or compare steps, the instruction pointer for the software application is incremented in block 622 and the execution of the software continues at the next instruction as shown in block 624. Process 600 may then end.

In another embodiment, the direct pointer accesses or XIP instructions within the application program may be replaced with dedicated functions calls to the simulator. The simulator may be local or remote. The dedicated function calls permit the functionality of the program to be tested during the development and debugging phase. Afterwards, the dedicated functions calls would be replaced by the appropriate direct pointer accesses or XIP instructions.

One of the benefits is that it allows easy integration of the existing device simulators to existing software development environments without major software adapters or the like.

It will be understood that each block of the flowchart illustrations, and combinations of blocks in the flowchart illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustrations may also be performed concurrently with other blocks or combinations of blocks, or even in a different sequence than illustrated without departing from the scope or spirit of the invention.

Accordingly, blocks of the flowchart illustrations support combinations of means for performing the specified actions, combinations of steps for performing the specified actions and program instruction means for performing the specified actions. It will also be understood that each block of the flowchart illustrations, and combinations of blocks in the flowchart illustrations, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected is:

1. A method for emulating access to a memory-mapped device requested during execution on a computer of software having a series of instructions comprising:
allocating protected memory space on the computer to correspond to the memory-mapped device;
detecting a memory access request to the protected memory space;
suspending execution of the memory access request;
generating a function call to a device simulator capable of fulfilling the memory access request;
requesting execution of the function call;
modifying a register of the computer based on a result of the function call; and
resuming execution of the software at an instruction subsequent to the memory access request wherein the subsequent instruction employs a content of the register.

2. The method of claim 1, further comprising:
generating a hardware interrupt in response to the memory access request to the protected memory space; and
executing the memory access request through the function call in response to the hardware interrupt.

3. The method of claim 1, wherein analyzing the memory access request to generate the function call to the simulator includes disassembling an operation code of the memory access request to determine the function call to the simulator.

4. The method of claim 1, wherein the detecting of the memory access request to the protected memory space is an access violation that is detected by an operating system of the computer.

5. The method of claim 1, further comprising:
converting the function call to a format suitable for transmission over a network; and
wherein the device simulator is connected to the network at a remote location.

6. The method of claim 1, further comprising:
processing the function call through a memory subsystem emulator prior to executing the function call through the device simulator.

7. The method of claim 1, wherein the memory access request is a direct pointer access or an execute in place access.

8. The method of claim 1, wherein the memory-mapped device is flash memory.

9. An apparatus for emulating access to a memory-mapped device comprising:
a protected memory space having at least a part of the memory space assigned to the memory-mapped device;
a processor operative to enable actions for:
detecting a memory access request to the protected memory space assigned to the memory-mapped device resulting from an instruction during execution of software;
suspending execution of the memory access request;
analyzing the memory access request to generate a function call to a device simulator capable of fulfilling the memory access request;
requesting execution of the function call;
modifying a register of the processor based on results of the function call; and
resuming execution of the software subsequent to the memory access request using a content of the register.

10. The apparatus of claim 9, wherein the processor is operative to enable further actions comprising:
generating a hardware interrupt in response to the memory access request to the protected memory space; and
executing the memory access request through the function call in response to the hardware interrupt.

11. The apparatus of claim 9, wherein analyzing the memory access request to generate the function call to the device simulator includes disassembling an operation code of the memory access request to determine the function call to the device simulator.

12. The apparatus of claim 9, wherein the detecting of the memory access request to the protected memory space is an access violation that is detected by an operating system of the computer.

13. The apparatus of claim 9, wherein the processor is operative to enable further actions comprising:
converting the function call to a format suitable for transmission over a network; and
wherein the device simulator is connected to the network at a remote location.

14. The apparatus of claim 9, wherein the processor is operative to enable further actions comprising:
processing the function call through a memory subsystem emulator prior to executing the function call through a device simulator.

15. The apparatus of claim 9, wherein the memory access request is a direct pointer access or an execute in place access.

16. The apparatus of claim 9, wherein the memory-mapped device is flash memory.

17. A system for emulating execution of software comprising:
a memory space;
a memory management unit for managing the memory space and allocating read and write protected memory space to a memory-mapped peripheral device; and
a processor operative in conjunction with the memory management unit to enable actions for:
detecting a memory access request to the protected memory space;
suspending execution of the memory access request;
executing a function call to a simulator capable of fulfilling the memory access request;
modifying a register of the processor based on results of the function call; and
resuming emulation of the software at an instruction subsequent to the memory access request and employing the register.

18. The system of claim 17, wherein the processor is further operative to enable actions comprising:
generating a hardware interrupt in response to the memory access request to the protected memory space; and
executing the memory access request through the function call in response to the hardware interrupt.

19. The system of claim 17, further comprising:
converting the function call to a format suitable for transmission over a network; and
wherein the device simulator is connected to the network at a remote location.

20. The system of claim 17, wherein the memory-mapped device is flash memory.
